(19) United States
(12) Patent Application Publication
(10) Pub. No.: US 2015/0012164 A1
(43) Pub. Date: Jan. 8, 2015

(54) METHOD AND APPARATUS FOR CONTROLLING DRIVING OF ROBOT

(71) Applicants: ELECTRONICS AND TELECOMMUNICATIONS RESEARCH INSTITUTE, Daejeon (KR); ASIA TECHNOLOGY CO., LTD., Daegu (KR)

(72) Inventors: Wonpil YU, Daejeon (KR); Sunglok Choi, Daejeon (KR); Jae Hyun Park, Daejeon (KR); Jee Hyung Lee, Daejeon (KR); Byung Hee Han, Daegu (KR); Sang Hoon Oh, Daegu (KR); Jee-Hwan Ryu, Cheonan-si (KR)

(73) Assignees: ASIA TECHNOLOGY CO., LTD., Daegu (KR); ELECTRONICS AND TELECOMMUNICATIONS RESEARCH INSTITUTE, Daejeon (KR)

(21) Appl. No.: 14/208,712

(22) Filed: Mar. 13, 2014

(30) Foreign Application Priority Data
Jul. 5, 2013 (KR) 10-2013-0078895

(51) Int. Cl. A01D 34/00; G05D 1/02

(52) U.S. Cl. CPC A01D 34/008; G05D 1/0219
USPC 701/23

(57) ABSTRACT

A method includes constructing map information by obtaining information of environment of a target mowing area, generating a 3-D space path along which the robot having mowing equipment mounted thereon is to move in the target mowing area based on the constructed map information, driving the robot so that the robot travels along the 3-D space path in response to an instruction for executing a mowing mode, extracting a ground area and an obstacle for robot driving by extracting information of a 3-D space when traveling along the 3-D space path, adaptively controlling the driving and mowing mode of the robot based on the extracted ground area and obstacle, and terminating the mowing mode when detecting a completion of the mowing for the target mowing area during the mowing mode.

### RELATED APPLICATION

This application claims the benefit of Korean Patent Application No. 10-2013-0078895, filed on Jul. 5, 2013, which is hereby incorporated by references as if fully set forth herein.

### FIELD OF THE INVENTION

The present invention relates to a scheme for controlling the driving of a robot, and more particularly, to a method and apparatus for controlling the driving of a robot which performs a mowing task autonomously in a 3-D (three-dimensional) space, such as an apple orchard.

### BACKGROUND OF THE INVENTION

Mowing is a seasonal work, carried out five times a year on average in a typical fruit farm. In particular, mowing is an essential task in order to increase yields and secure quality of crops, such as apples, pears, and peaches.

Recently, people's preference for fruit raised in an environment-friendly manner is increasing, and efforts to introduce environment-friendly agricultural techniques are also increased. Inherent to environment-friendly agricultural techniques, it is very important to minimize the use of agricultural chemicals, such as herbicide, which subsequently leads to the proliferation of mowing harmful to the growth of fruit trees.

In particular, the mowing task is a seasonal work carried out intensively in the middle of summer usually starting from June to August, lasting two to three days to complete the mowing task for a moderate-sized orchard. In this regard, physical fatigue for a farmer due to the mowing task is relatively severe. In particular, considering a recent ageing trend, it is expected that the physical fatigue degree of a farmer will be further great. Furthermore, when a farmer performs a mowing task, a special care should be paid to avoid injury due to flying debris in a mowing region or unskillful use of a mower.

Furthermore, a mowing task may be called a typical 3D (Dirty, Dull, and Dangerous) task considering the fact that the mowing task is the repetition of a very simple task, and an average area of a fruit farm covers several thousands of square meters.

Advanced mowing machines are recently introduced into fruit orchards in order to solve such difficulties inherent in a mowing task. Types of mowing machines include a brush cutter, a walk-behind mower, and a riding mower. The riding (or user riding) mower is the most recent model and relatively expensive.

In the case of the riding mower, since a user sits on the machine for operation, physical fatigue is much smaller than that from the brush cutter and the walk-behind type mower, and the riding mower covers a wider area than the other types of mowers. The riding mower is chiefly purchased in order to perform a mowing work on a relatively large fruit tree field of several thousands of square meters. In particular, the riding mower is actively introduced because the size of a fruit farm gradually becomes large.

Nevertheless, a physical fatigue still remains because a mowing work is simple and intensively performed in the middle of summer and a user has to perform the mowing work for a long time while sitting on the riding mower. Furthermore, the riding mower is disadvantageous in that mowing is not performed well in those areas between fruit trees due to the user's riding posture. Another difficulty is a possibility of an accident during the mowing work that the user may get scratches on his or her face or the user may be poked in the eye by tree branches.

As an effort to automate such tasks, major companies are recently carrying out researches on a robot for mowing. In particular, companies, such as John Deere, Friendly robotics, Iguide robotics, and husqvarna, have released robots for mowing. However, most of the mowing robots in the market have been developed for lawn management purposes in such areas as residential gardens and thus are not suitable for tasks on irregular surfaces and slopes commonly found in ordinary fruit orchards and are difficult in tasks for removing weeds between trees.

In particular, an existing lawn mowing robot is commonly driven by the battery because it is chiefly used to mow the lawn in a relatively narrow area. Accordingly, the existing lawn mowing robot has many difficulties in its output or mowing performance if the robot operates in an irregular surface of a wide farmland, such as a fruit tree field.

Furthermore, an existing lawn mowing robot chiefly operates in such a manner that a cable through which an electrical current flows is buried in the ground in advance and the robot recognizes a mowing area by sensing an electric field that is formed by the electric current while moving. Such a method is suitable for environments that can be relatively easily managed, such as gardens and golf courses, but is problematic in that it is difficult to apply the method to environments including a wide mowing area, such as an orchard field, and different geographical conditions, such as slopes, from cost and practical viewpoints.

### SUMMARY OF THE INVENTION

In view of the above, the present invention proposes a scheme for automatic mowing in an orchard using a robot and proposes an operation mode in which information of a target mowing area, such as the size and structure of the orchard field, is obtained (or mapped), a task path for an effective mowing work (e.g., a 3-D space path along which a mowing robot moves) is established, and the driving of the robot for mowing is remotely controlled in order to execute a mowing work.

In accordance with an aspect of the present invention, there is provided a method for controlling driving of a robot, which includes constructing map information by obtaining information of environment of a target mowing area, generating a 3-D space path along which the robot having mowing equipment mounted thereon is to move in the target mowing area based on the constructed map information, driving the robot so that the robot travels along the 3-D space path in response to an instruction for executing a mowing mode, extracting a ground area and an obstacle for robot driving by extracting information of a 3-D space when traveling along the 3-D space path, adaptively controlling the driving and mowing mode of the robot based on the extracted ground area and obstacle, and terminating the mowing mode when detecting a completion of the mowing for the target mowing area during the mowing mode.

In the exemplary embodiment, the information of the environment may be obtained by a driving sensor mounted on the robot.

In the exemplary embodiment, the driving sensor may include one or more of a wheel encoder, a speedometer, a laser sensor, and a camera.

In the exemplary embodiment, the user provides the information of the environment based on GPS map information.

In the exemplary embodiment, the mowing mode may be executed by a user input received through a manipulation switch mounted on the robot.

In the exemplary embodiment, the mowing mode may be executed in response to a mowing command signal wirelessly received from a remote place.

In the exemplary embodiment, the information of the 3-D space may be extracted using any one or a combination of a 3-D lidar, a 2-D or 3-D scanning laser, and a stereo camera.

In the exemplary embodiment, the extracting of the ground area and the obstacle may includes obtaining a structure of surrounding geographic features in which the robot travels and a distribution of weeds during the mowing mode, and controlling a height or rotating speed of a blade of a knife for mowing that is mounted on the mowing equipment based on the obtained structure of the surrounding geographic features and the obtained distribution of weeds.

In the exemplary embodiment, the extracting of the ground area and the obstacle may includes obtaining a structure of surrounding geographic features and a distribution of weeds in which the robot travels during the mowing mode, controlling driving speed of the robot based on the obtained structure of the surrounding geographic features and the obtained distribution of weeds.

In the exemplary embodiment, the extracting of the ground area and the obstacle may include visually and acoustically notifying a result of detection when detecting the obstacle.

In the exemplary embodiment, the extracting of the ground area and the obstacle may includes monitoring whether or not the robot has been broken during the mowing mode, visually and acoustically notifying a failure state when monitoring that the robot has been broken.

In the exemplary embodiment, the completion of the mowing may be monitored when detecting a landmark for an end installed at a specific location of the target mowing area.

In the exemplary embodiment, further includes automatically returning the robot to a robot charging station when the mowing mode is terminated.

In accordance with another aspect of the exemplary embodiment of the present invention, there is provided an apparatus for controlling driving of a robot, which includes a map generation block for constructing map information by obtaining information of an environment of a target mowing area, an information DB for storing the constructed map information, a path generation block for generating a 3-D space path along which the robot having mowing equipment mounted thereon is to move in the target mowing area based on the map information stored in the information DB, a control block for driving the robot so that the robot executes a mowing mode along the 3-D space path in response to an instruction for executing the mowing mode, and a surrounding environment acquisition unit for obtaining information of surrounding environments in which the robot travels by extracting information of a 3-D space when the robot executes the mowing mode and providing the information of the surrounding environments to the control block, wherein the control block terminates the mowing mode when the surrounding environment acquisition unit detects a completion of mowing for the target mowing area.

In the exemplary embodiment, the surrounding environment acquisition unit may obtains a structure of surrounding geographic features and a distribution of weeds in which the robot travels while the robot executes the mowing mode and provides the obtained structure of the surrounding geographic features and the obtained distribution of the weeds to the control block as the information of the surrounding environment, and the control block controls a height or rotating speed a blade of a knife for mowing mounted on the mowing equipment based on the obtained structure of the surrounding geographic features and the obtained distribution of the weeds.

In the exemplary embodiment, the surrounding environment acquisition unit may obtain a structure of surrounding geographic features and a distribution of weeds in which the robot travels while the robot executes the mowing mode and provides the obtained structure of the surrounding geographic features and the obtained distribution of the weeds to the control block as the information of the surrounding environment, and the control block controls driving speed of the robot based on the obtained structure of the surrounding geographic features and the obtained distribution of the weeds.

In the exemplary embodiment, the surrounding environment acquisition unit may extract the information of the 3-D space using one or more of a 3-D lidar, a 2-D or 3-D scanning laser, and a stereo camera.

In the exemplary embodiment, the apparatus further include an alarm block for visually and acoustically notifying a result of detection if the obstacle is detected as the information of the surrounding environment.

In the exemplary embodiment, the apparatus further includes a failure management unit for monitoring whether or not the robot has been broken during the mowing mode, an alarm block for visually and acoustically notifying a failure state if it is monitored that the robot has been broken.

In the exemplary embodiment, the control block may return the robot to a robot charging station when the surrounding environment acquisition unit detects the completion of the mowing.

### BRIEF DESCRIPTION OF THE DRAWINGS

The objects and features of the present invention will become apparent from the following description of embodiments given in conjunction with the accompanying drawings, in which:

FIG. 1 is a block diagram of an apparatus for controlling the driving of a robot in accordance with an embodiment of the present invention;

FIG. 2 is a flowchart illustrating major processes of controlling the driving of a robot for mowing in accordance with an embodiment of the present invention; and

FIG. 3 is a conceptual diagram illustrating a process of generating a 3-D space path by obtaining information of an environment from a target mowing area.

### DETAILED DESCRIPTION OF THE EMBODIMENTS

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the claims.

In describing the embodiments of the present invention, a detailed description of known functions or constructions related to the present invention will be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

Hereinafter, embodiments of the present invention will be described in detail with reference to the accompanying drawings which form a part hereof.

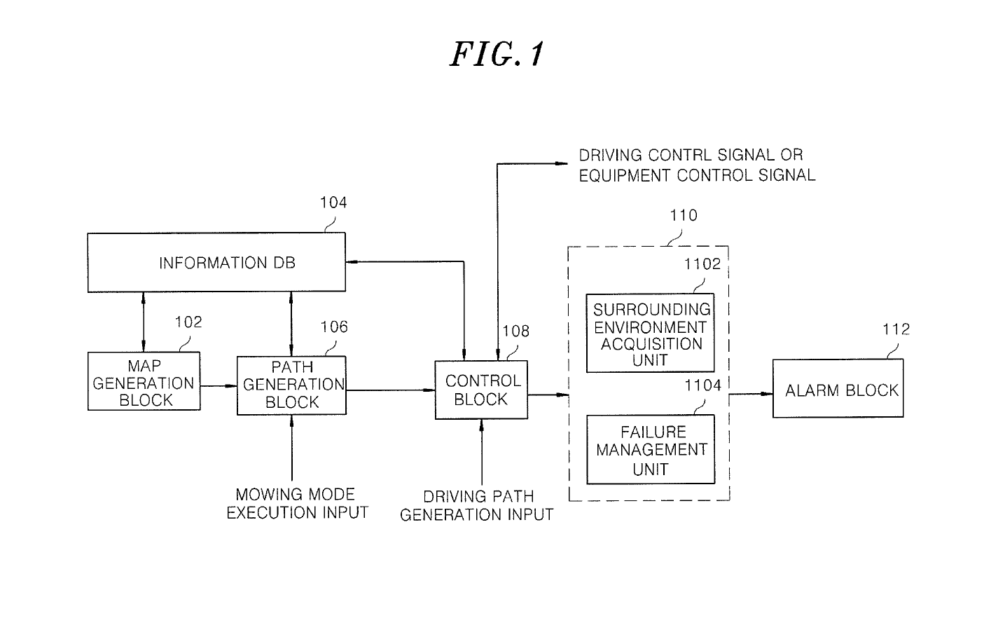

FIG. 1 is a block diagram of an apparatus for controlling the driving of a robot in accordance with an embodiment of the present invention. The controlling the driving of a robot may include a map generation block 102, an information DB 104, a path generation block 106, a control block 108, an environment management block 110, and an alarm block 112. The environment management block 110 may include a surrounding environment acquisition unit 1102 and a failure management unit 1104.

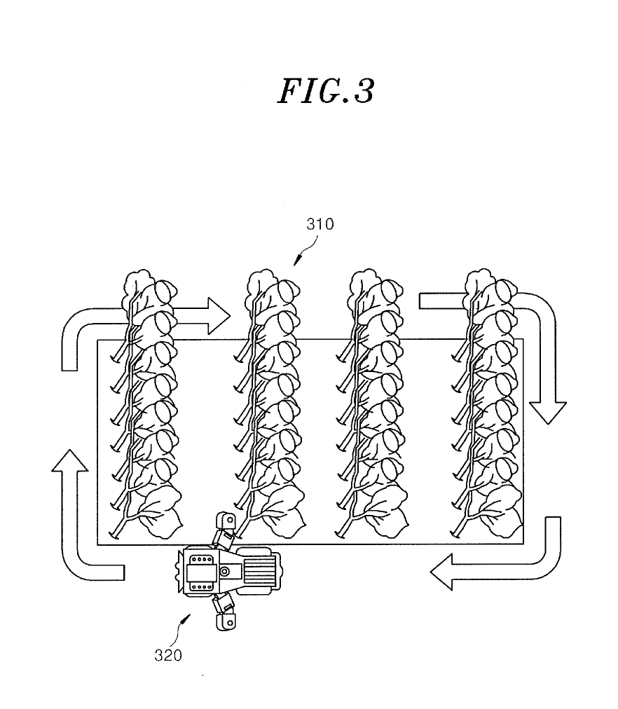

Referring to FIG. 1, the map generation block 102 constructs map information by obtaining (or mapping) information of the environment of an area to be mowed (e.g., an orchard field) and stores (or registers) the constructed map information in the information DB 104. The information of the environment may be automatically obtained by a driving sensor (e.g., a driving sensor including one or more of a wheel encoder, a speedometer, a laser sensor, and a camera) mounted on a robot (i.e., a robot for mowing) or may be obtained in response to a user input (e.g., an input, such as the horizontal and vertical size of a target mowing area, the width between fruit trees, or the number of columns of fruit trees) based on GPS map information. If the information of the environment is automatically obtained by the driving sensor mounted on the robot, a robot 320 on which a driving sensor is mounted will travel a target mowing area 310 in the direction of an arrow as shown in FIG. 3, for example.

When a driving path generation input is received from input means (not shown), the path generation block 106 can provide a function of generating a 3-D space path along which a robot having mowing equipment (e.g., a mower) mounted thereon moves in the target mowing area based on the map information stored in the information DB 104, storing (or registering) the generated 3-D space path in the information DB 104, notifying the control block 108 of the generation of the 3-D space path. The driving path generation input transferred to the path generation block 106 may be a user input through a manipulation switch mounted on the robot or may be a remote input that is wirelessly transmitted by and received from a remote place.

The information DB 104 may store (or register) a plurality of pieces of information of the map of a target mowing area and a plurality of 3-D space paths corresponding to the information of the map of the target mowing area. In such a case, a plurality of target mowing areas that is present in different areas from a positional (geopolitical) viewpoint can correspond to a plurality of 3-D space paths. That is, the information DB 104 can register (or store) a target mowing area A and a 3-D space path A-1 corresponding to the target mowing area A, a target mowing area B and a 3-D space path B-1 corresponding to the target mowing area B, and a target mowing area C and a 3-D space path C-1 corresponding to the target mowing area C, which are classified by different delimiters.

The control block 108 includes a microprocessor for controlling the overall operation and function of a robot on which, for example, mowing equipment (e.g., a mower) has been mounted. When a mowing mode execution input is received (or instructed), the control block 108 can provide a function of enabling a robot (i.e., a robot for mowing) to execute a mowing mode (i.e., a mowing work) (e.g., generate a driving control signal) while moving along the 3-D space path fetched from the information DB 104. The mowing mode may be executed (e.g., executed in a manual mode) when a user input is received through a manipulation switch mounted on a robot or may be executed (e.g., executed in an automatic mode) when a mowing command signal is received wirelessly from a remote place (e.g., a remote controller or a joystick for a remote operation). Wireless communication between the remote place and the robot may be performed using a communication network, such as Wi-Fi, 3G communication, or 4G communication.

For example, tree trunks need to be recognized in order to remove weeds between the trees. Here, a tree is recognized from 3-D spatial information obtained through a 3-D distance measurement sensor such as a stereovision sensor or a laser sensor. After a tree is recognized, a relative distance and orientation between the tree and a robot are measured (i.e., a robot pose is recognized), a control command for actual mowing is generated based on the measured relative distance and orientation, and the robot performs a mowing work in response to the generated control command.

Likewise, in order to recognize a slope, a sensor capable of obtaining information of 3-D space, such as a 3-D scanning laser, may be used. In order to perform a mowing work in such an environment, a robot needs to autonomously generate a robot moving path in the 3-D space. A 3-D space path for generating the robot moving path may be generated using a path generation algorithm under various conditions, such as a method of minimizing kinetic energy of the robot or a method of minimizing a robot moving path in a 3-D space.

The control block 108 can provide a function of controlling the height or rotating speed of the blade of a knife for mowing which has been mounted on mowing equipment (e.g., generating an equipment control signal) or controlling the driving speed of a robot based on the structure of surrounding geographic features and a distribution of weeds in which the robot travels, which are received from the surrounding environment acquisition unit 1102 of the environment management block 110 during the mowing mode. The blade of the knife for mowing (e.g., the blade of a rotary type knife) mounted on mowing equipment may be mounted at the bottom of the center of the body corresponding to the body of a robot or may be mounted at the bottom of a folding type wing on one side or both sides of the body of the robot. If the blade of a rotary type knife is mounted on the bottom of a folding type wing, a mowing work may be performed in the area under a tree to which it is not easy for a robot to access.

Furthermore, the control block 108 can provide a function of pausing the driving and mowing mode of a robot when obstacle (e.g., a person or other natural objects) detection information is received from the surrounding environment acquisition unit 1102 during the mowing mode, a function of pausing the driving and mowing mode of a robot when failure detection information (i.e., a failure detection signal) is received from the failure management unit 1104, and a function of terminating the mowing mode when detection information of the completion of mowing is received from the surrounding environment acquisition unit 1102 and automatically returning the robot to a robot charging station. Here, if it is determined that the size of an obstacle is negligibly small in performing a mowing work, the control block 108 may not pause the mowing mode of the robot.

A point of time at which a landmark for the end (e.g., a recognizable paper mark attached to a post or tree trunk or a plastic mark that can easily be reflected) installed at a specific location of a target mowing area (e.g., the end of a passage) is detected (or monitored) may be detected as a point of time at which mowing is completed.

The surrounding environment acquisition unit 1102 of the environment management block 110 can provide a function of obtaining information of surrounding environments, such as the structure of surrounding geographic features (e.g., obstacles) and a distribution of weeds in which a robot travels, using various 3-D space sensors (e.g., any one or more of a 3-D lidar, a 2-D or 3-D scanning laser, and a stereo camera) mounted on the robot and configured to provide information of a 3-D distance, analyzing the obtained information of the surrounding environments in the form of information of a 3-D space, and transferring the analyzed information of the 3-D space to the control block 108, when the robot executes the mowing mode under the control of the control block 108. The information of the 3-D space that is transferred to the control block 108 may selectively include, for example, the structure of surrounding geographic features, a ground area, an obstacle area, a distribution of weeds, the length of weeds, and information of the detection of a landmark for an end. Here, the ground area may be extracted as a 3-D point cloud through down-sampling using a voxel grid filter.

Furthermore, the surrounding environment acquisition unit 1102 can provide a function of transferring the results of detection to the alarm block 112 when an obstacle is detected in a robot's traveling path through the 3-D space sensors and transferring the results of detection to the alarm block 112 when a landmark for an end is detected in a robot's traveling path through the 3-D space sensors.

The failure management unit 1104 can provide a function of monitoring (or detecting) whether or not various devices mounted on a robot are broken when the robot executes the mowing mode while traveling along a 3-D space path, generating a corresponding failure detection signal if it is determined that a specific device is broken, and providing the failure detection signal to the control block 108 and the alarm block 112.

The alarm block 112 can provide a function of generating a corresponding alarm when an obstacle detection result or an end landmark detection result is received from the surrounding environment acquisition unit 1102. Here, the alarm may include any one of or both an auditory alarm (i.e., the generation of an alarm) and a visual alarm (i.e., the turn-on or off of an alarm lamp). Assuming that a robot for mowing is executed (or controlled) in an automatic mode through a remote controller or joystick for remote control, the alarm block 112 can wirelessly transmit auditory alarm data and/or visual alarm data to the remote controller or joystick for remote control so that an alarm is generated in a remote place that is managed by a user.

Furthermore, the alarm block 112 may generate a corresponding failure alarm (i.e., provide auditory and/or visual notification for the failure state of a robot) when a failure detection signal is received from the failure management unit 1104 or may wirelessly transmit auditory alarm data and/or visual alarm data related to the failure to a remote controller or joystick for remote control so that the failure alarm for the robot is generated in a remote place that is managed by a user.

A series of processes of adaptively controlling the driving of a robot for mowing depending on the surrounding environments of a target mowing area using the apparatus for controlling the driving of a robot in accordance with the present invention are described in detail below.

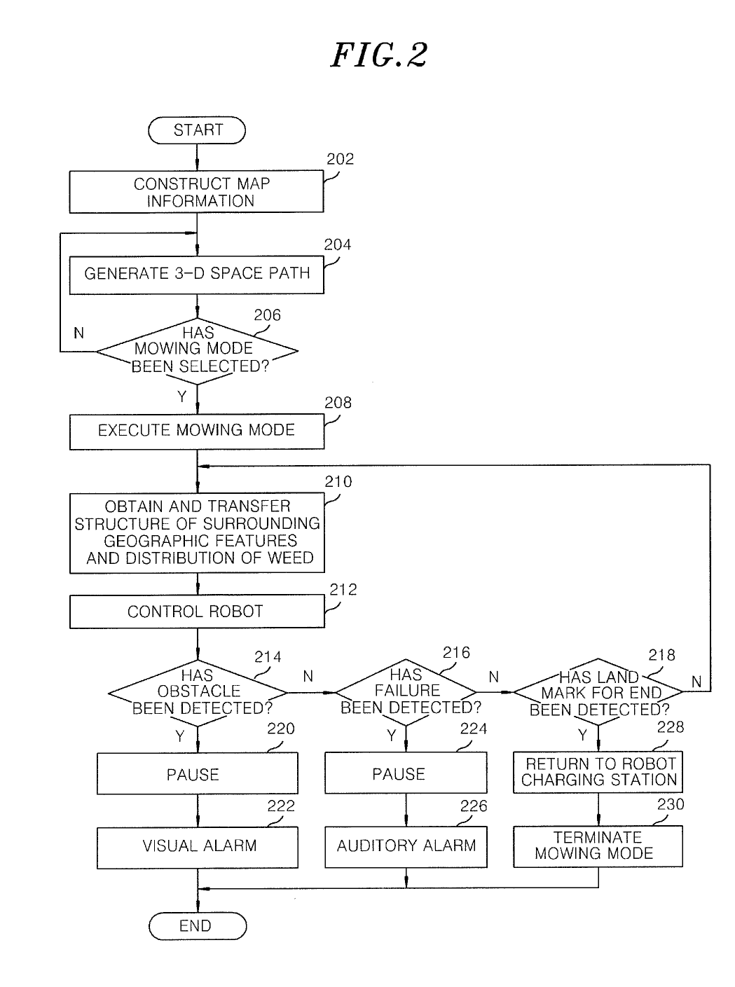

FIG. 2 is a flowchart illustrating major processes of controlling the driving of a robot for mowing in accordance with an embodiment of the present invention.

Referring to FIG. 2, the map generation block 102 constructs map information by obtaining information of the environment of a target mowing area (e.g., a fruit tree field) at step 202. The spatial information of the environment may be automatically obtained by a driving sensor (e.g., a driving sensor including one or more of a wheel encoder, a speedometer, a laser sensor, and a camera) mounted on a robot or may be obtained in response to a user input (e.g., an input, such as the horizontal and vertical size of a target mowing area, the width between fruit trees, or the number of columns of fruit trees) based on GPS map information.

When a driving path generation input is received, the path generation block 106 generates a 3-D space path along which the robot having mowing equipment (e.g., a mower) mounted thereon moves in the target mowing area based on the map information stored in the information DB 104 and stores the generated 3-D space path in the information DB 104 at step 204. The driving path generation input may be a user input through a manipulation switch mounted on the robot or may be a remote input that is wirelessly transmitted by and received from a remote place (e.g., a remote controller or joystick for remote control).

Next, the control block 108 checks whether or not input for executing the mowing mode by a user manipulation is received (i.e., the mowing mode is selected) at step 206. If, as a result of the check, the input for executing the mowing mode is found to be received, the control block 108 executes the mowing mode (i.e., the mowing work) (generates a driving control signal) while driving the robot (i.e., the robot for mowing) along the 3-D space path fetched from the information DB 104 at step 208. The mowing mode may be executed (i.e., executed in a manual mode) by a user manipulation received through the manipulation switch mounted on the robot or may be executed (i.e., executed in an automatic mode) in response to a mowing command signal wirelessly received from a remote place (e.g., a remote controller for a remote operation or joystick).

When the robot executes the mowing mode as described above, the surrounding environment acquisition unit 1102 obtains information of surrounding environments, such as the structure of surrounding geographic features (e.g., obstacles) and a distribution of weeds in which the robot travels, the length of weeds, and the detection of a landmark for an end, using various 3-D space sensors (e.g., any one or two or more of a 3-D lidar, a 2-D or 3-D scanning laser, and a stereo camera) mounted on the robot and configured to provide information of a 3-D distance, analyzes the obtained information of the surrounding environments in the form of information of a 3-D space, and transfers the analyzed information of the 3-D space to the control block 108. If it is determined from monitoring (or detecting) whether or not various devices mounted on the robot are broken that a specific device has been broken, the failure management unit 1104 generates a corresponding failure detection signal and transfers the corresponding failure detection signal to the control block 108 at step 210.

In response thereto, the control block 108 controls the robot, such as controlling the height or rotating speed of the blade of a knife for mowing mounted on mowing equipment (i.e., generating an equipment control signal) or controlling the driving speed of the robot based on the structure of the surrounding geographic features and the distribution of weeds at step 212.

The control block 108 randomly checks whether or not obstacle detection information, a failure detection signal, and information of the detection of a landmark for an end at steps 214, 216, and 218. If, as a result of the check at step 214, it is determined that the obstacle detection information has been received from the surrounding environment acquisition unit 1102, the control block 108 pauses the driving and mowing mode of the robot at step 220. If it is determined that the size of an obstacle is negligibly small in performing the mowing work, the control block 108 may not pause the mowing mode of the robot.

At the same time, the path block 112 generates an auditory alarm and/or a visual alarm for notifying the outside (e.g., a mowing work administrator) that further driving and a further mowing work are difficult because the obstacle is present near the robot based on the obstacle detection information received from the surrounding environment acquisition unit 1102 at step 222. The obstacle generation alarm may be wirelessly transmitted to a remote place (e.g., a remote controller for remote control or joystick) so that the alarm is generated in the remote place.

If, as a result of the check at step 216, it is determined that the failure detection signal has been received from the failure management unit 1104, the control block 108 pauses the driving and mowing mode of the robot at step 224.

At the same time, the path block 112 generates an auditory alarm and/or a visual alarm for notifying the outside (e.g., a mowing work administrator) that the robot has been broken based on the failure detection signal received from the failure management unit 1104 at step 226. The failure generation alarm may be wirelessly transmitted to a remote place (e.g., a remote controller for remote control or joystick) so that the alarm is generated in the remote place.

If, as a result of the check at step 218, it is determined that information of the detection of the landmark for an end has been received from the surrounding environment acquisition unit 1102, the control block 108 terminates the mowing mode that is being executed in the robot and automatically returns the robot to a robot charging station at step 228. In the present invention, the robot has been illustrated as being automatically returned to the robot charging station when a landmark for an end is detected, but the present invention is not limited thereto. For example, the robot may be set so that it returns to the robot charging station through the manual manipulation of a task administrator, if necessary.

When the robot is placed at the right position of the robot charging station, the control block 108 terminates the driving mode of the robot at step 230, thereby completing the mowing work and the automatic return of the robot.

In accordance with the present invention, a robot for mowing can automatically perform a mowing work while autonomously moving in a target mowing area (e.g., an orchard field) in such a way as to generate a 3-D space path (i.e., a working plan path) along which the robot moves in the target mowing area based on map information constructed by obtaining information of the environment of the target mowing area and to extract a ground area and an obstacle for robot driving by extracting information of a 3-D space when the robot performs the mowing work along the 3-D space path. Accordingly, the mowing work can be efficiently performed even without the physical labor of a worker.

Furthermore, the present invention can be applied to the delivery of fruit trees and the spraying of agricultural pesticides using the autonomous operation function in addition to a mowing work.

In particular, the present invention can provide users with various advantages, such as improved agricultural (e.g., fruit tree) productivity, improved quality of life of farmers, and an effective working plan, by adaptively applying the reset of one-touch, autonomous moving, mowing between trees, the switching of a manual mode to an automatic mode and vice versa, automatic return, a remote operation, automatic failure notification, and automatic control of the height of the blade of a knife and rotating speed depending on a mowing environment (e.g., a ground area and an obstacle) in a target mowing area.

While the invention has been shown and described with respect to the preferred embodiments, the present invention is not limited thereto. It will be understood by those skilled in the art that various changes and modifications may be made without departing from the scope of the invention as defined in the following claims.

Accordingly, the scope of the present invention should be interpreted based on the following appended claims, and all technical spirits within an equivalent range thereof should be construed as being included in the scope of the present invention.

What is claimed is:

1. A method for controlling driving of a robot, comprising:
constructing map information by obtaining information of a target environment to be mowed;
generating a path along which the robot equipped with a mowing module mounted thereon moves in the target environment on the basis of the constructed map information;
driving the robot so that the robot travels along the generated path in response to a mowing command;
extracting a free area and an occupied area while traveling along the path;
adaptively controlling a driving and mowing mode of the robot based on the extracted free area and occupied area; and
terminating the mowing mode when detecting a completion of the mowing for the target mowing area during the mowing mode.

2. The method of claim 1, wherein the information of the environment is obtained by a driving sensor mounted on the robot.

3. The method of claim 2, wherein the driving sensor comprises one or more of a wheel encoder, a speedometer, a laser sensor, and a camera.

4. The method of claim 1, wherein the information of the environment is obtained in response to a user input based on map information.

5. The method of claim 1, wherein the mowing mode is executed by a user input received through a manipulation switch mounted on the robot.

6. The method of claim 1, wherein the mowing mode is executed in response to a mowing command signal wirelessly received from a remote place.

7. The method of claim 1, wherein the information of the 3-D space is extracted using any one or a combination of a 3-D lidar, a 2-D or 3-D scanning laser, and a stereo camera.

8. The method of claim 1, wherein the extracting of the free area and the occupied area comprises:
obtaining a structure of surrounding geographic features in which the robot travels and a distribution of weeds during the mowing mode; and
controlling a height or rotating speed of a blade of a knife for mowing that is mounted on the mowing equipment based on the obtained structure of the surrounding geographic features and the obtained distribution of weeds.

9. The method of claim 1, wherein the extracting of the free area and the occupied area comprises:
obtaining a structure of surrounding geographic features and a distribution of weeds in which the robot travels during the mowing mode;
controlling driving speed of the robot based on the obtained structure of the surrounding geographic features and the obtained distribution of weeds.

10. The method of claim 1, wherein the extracting of the free area and the occupied area comprises visually and acoustically notifying a result of detection when detecting an obstacle.

11. The method of claim 1, wherein the extracting of the free area and the occupied area comprises:
monitoring whether or not the robot has been broken during the mowing mode; and
visually and acoustically notifying a failure state when monitoring that the robot has been broken.

12. The method of claim 1, wherein the completion of the mowing is monitored when detecting a landmark indicating end of a task installed at a specific location of the target mowing area.

13. The method of claim 1, further comprising automatically returning the robot to a robot charging station when the mowing mode is terminated.

14. An apparatus for controlling driving of a robot, comprising:
a map generation block for constructing map information by obtaining information of an environment of a target mowing area;
an information DB for storing the constructed map information;
a path generation block for generating a 3-D space path along which the robot having mowing equipment mounted thereon is to move in the target mowing area based on the map information stored in the information DB;
a control block for driving the robot so that the robot executes a mowing mode along the 3-D space path in response to an instruction for executing the mowing mode; and
a surrounding environment acquisition unit for obtaining information of surrounding environments in which the robot travels by extracting information of a 3-D space when the robot executes the mowing mode and providing the information of the surrounding environments to the control block,
wherein the control block terminates the mowing mode when the surrounding environment acquisition unit detects a completion of mowing for the target mowing area.

15. The apparatus of claim 14, wherein:
the surrounding environment acquisition unit obtains a structure of surrounding geographic features and a distribution of weeds in which the robot travels while the robot executes the mowing mode and provides the obtained structure of the surrounding geographic features and the obtained distribution of the weeds to the control block as the information of the surrounding environment, and
the control block controls a height or rotating speed a blade of a knife for mowing mounted on the mowing equipment based on the obtained structure of the surrounding geographic features and the obtained distribution of the weeds.

16. The apparatus of claim 14, wherein:
the surrounding environment acquisition unit obtains a structure of surrounding geographic features and a distribution of weeds in which the robot travels while the robot executes the mowing mode and provides the obtained structure of the surrounding geographic features and the obtained distribution of the weeds to the control block as the information of the surrounding environment, and
the control block controls driving speed of the robot based on the obtained structure of the surrounding geographic features and the obtained distribution of the weeds.

17. The apparatus of claim 14, wherein the surrounding environment acquisition unit extracts the information of the 3-D space using one or more of a 3-D lidar, a 2-D or 3-D scanning laser, and a stereo camera.

18. The apparatus of claim 14, further comprising an alarm block for visually and acoustically notifying a result of detection if the obstacle is detected as the information of the surrounding environment.

19. The apparatus of claim 14, further comprising:
a failure management unit for monitoring whether or not the robot has been broken during the mowing mode;
an alarm block for visually and acoustically notifying a failure state if it is monitored that the robot has been broken.

20. The apparatus of claim 14, wherein the control block returns the robot to a robot charging station when the surrounding environment acquisition unit detects the completion of the mowing.
